(19) United States
(12) Patent Application Publication
(10) Pub. No.: US 2026/0350146 A1
(43) Pub. Date: Nov. 5, 2026

(54) MECHANISM FOR INTERPOSING OPERATING SYSTEM CALL DISPATCHER AT THE TRAP LAYER

(71) Applicant: THALES DIS CPL USA, Inc., Austin, TX (US)

(72) Inventors: Aditya Prakash SRIVASTAVA, Noida (IN); Vinay SHARMA, Delhi (IN); Feng PAN, San Ramon, CA (US); Mihai SPATAR, Cluj-Napoca (RO)

(73) Assignee: THALES DIS CPL USA, Inc., Austin, TX (US)

(21) Appl. No.: 19/181,499

(22) Filed: Apr. 17, 2025

(51) Int. Cl. G06F 21/54; G06F 9/30; G06F 9/54

(52) U.S. Cl. CPC G06F 21/54; G06F 9/30145; G06F 9/547; G06F 2221/033

(57) ABSTRACT

A method (500) and system (100) for handling system call of operating system is disclosed. The method (500) comprises receiving at least one system call from application (302). Each system call comprises set of instructions. The method (500) may comprise scanning instructions of operating system trap handler (304) to identify binary opcode. The method (500) may further comprise invoking private system call dispatcher (306) at binary opcode. The private system call dispatcher (306) refers to private system call vector table (308). The method (500) may further comprise receiving system call number corresponding to system call by private system call dispatcher (306). Further, the method (500) further comprises identifying system call handler corresponding to system call based on private system call vector table (308) and system call number. The method (500) comprises executing system call handler based on the system call.

### FIELD OF THE INVENTION

The present disclosure relates to a field of computer systems, and more specifically to a method and system for handling system calls of an operating system executing in a computing environment.

### BACKGROUND OF THE INVENTION

A system call is a mechanism that allows a program to request a service from an operating system (OS). System calls provides an interface between user-level applications and a kernel, enabling applications to access hardware or perform privileged tasks. System calls are interfaces through which user applications interact with the operating system to perform functions such as reading or writing files, handling processes, or allocating memory.

However, the challenge arises from this approach is tied to the specific implementation of a system call stack in the operating system. Different operating systems, or even different versions of the same operating system, may implement system calls in slightly different ways.

Most security software may need to inspect the system calls at a higher layer of the stack to gain deeper access to system call information. However, the tight coupling with the operating system's architecture increases the risk that changes in future versions of the operating system may render such inspection ineffective. As a result, security software that is developed for one version of the operating system may become ineffective or even inoperable if the system call stack is altered in subsequent updates. In such cases, the software provider must refactor the security software to adjust its inspection and align it with the new system call architecture.

Moreover, the position of such inspection in the system call execution stack plays a critical role in the flexibility and robustness of the security software. A typical system call stack is layered, starting from low-level hardware interactions, and moving up to higher levels where more abstract functions are managed.

Therefore, there is a need for a method and a system that addresses the above mentioned technical problems by handling system call of the operating system.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide a method for handling system call of an operating system executing in a computing environment, the method may comprise receiving at least one system call from an application. Each of at least one of the system calls comprises a set of instructions. The method may further comprise scanning the set of instructions of the operating system trap handler to identify a binary opcode. The method may further comprise invoking a private system call dispatcher at the binary opcode. The private system call dispatcher refers to a private system call vector table. The method may further comprise receiving a system call number corresponding to at least one of the system calls by the private system call dispatcher. The method further comprises identifying a system call handler corresponding to at least one of the system call based on the private system call vector table and the system call number. The private system call vector table is referred to identify the system call handler based on the system call number. The method further comprises executing the system call handler based on the at least one of the system call.

According to some example embodiments, the private system call vector table comprises a plurality of entries of system call handlers corresponding to each of at least one of the system calls. Further, the plurality of entries comprise a subset of system call handlers that are interposed, and each of at least one of the system call corresponds to one system call number.

According to some example embodiments, the system call number is used as an index in the private system call vector table to identify the system call handler.

According to some example embodiments, the method further comprises identifying a stub function based on the index in the private system call vector table and the system call handler. The stub function comprises additional instructions to handle a request from a trap layer. Further, the method comprises executing the stub function, before executing the system call handler based on at least one of the system call number.

According to some example embodiments, the step of invoking the private system call dispatcher comprises replacing a default system call dispatcher with the private system call dispatcher.

Some example embodiments disclosed herein provide a system for handling system call of the operating system. The system comprises a processor, and a memory communicatively coupled to the processor. The memory stores processor instructions, which when executed by the processor, cause the processor to receive at least one system call from an application. Each of at least one of the system calls comprises a set of instructions. The processor executable instructions cause the processor to scan the set of instructions of the operating system trap handler to identify a binary opcode. Further, the processor executable instructions cause the processor to invoke a private system call dispatcher at the binary opcode. The private system call dispatcher refers to a private system call vector table. The processor executable instructions cause the processor to receive a system call number corresponding to the at least one system call by the private system call dispatcher. The processor executable instructions cause the processor to identify a system call handler corresponding to at least one of the system call based on the private system call vector table and the system call number. The private system call vector table is referred to identify the system call handler based on the system call number. Further, the processor executable instructions cause the processor to execute the system call handler based on the at least one of the system call.

Another example embodiments disclosed herein provide a non-transitory computer-readable medium storing computer-executable instructions for handling system call of an operating system executing in a computing environment. The computer-executable instructions configured for receiving at least one system call from an application. Each of at least one of the system calls comprises a set of instructions. Further, the computer-executable instructions is configured for scanning the set of instructions of the operating system trap handler to identify a binary opcode. The computer-executable instructions is configured for invoking a private system call dispatcher at the binary opcode. The private system call dispatcher refers to a private system call vector table. The computer-executable instructions further configured for identifying a system call number corresponding to the at least one system call by the private system call dispatcher. The computer-executable instructions is configured for identifying a system call handler corresponding to at least one of the system call based on the private system call vector table and the system call number. The private system call vector table is referred to identify the system call handler based on the system call number. Further, the computer-executable instructions is configured for executing the system call handler based on the at least one of the system call.

The foregoing summary is illustrative only and is not intended to be in any way limiting. In addition to the illustrative aspects, embodiments, and features described above, further aspects, embodiments, and features will become apparent by reference to the drawings and the following detailed description.

### DEFINITIONS

The term “Application” as used herein in the specification may refer to a software that a user (for example, a human or another software) may use to perform certain function on a computer system. For example, web browser, email client, excel, games, command prompt.

The term “System software” as used herein in the specification may refer to a software that is used by another software to augment their features. The system software is usually implemented as libraries.

The term “Library” as used herein in the specification may be used to distribute functions that multiple applications and other libraries can use. For example, every system has a standard library. Other examples are libraries to provide cryptography, advanced mathematics, compression.

The term “Operating system” as used herein in the specification may provide management for hardware like storage devices, network interfaces, along with providing process and memory management, amongst a host of other capabilities. Example of the operating systems are Microsoft Windows, Linux, MacOS, and Android. The operating systems provide a mechanism called system calls through which applications can access hardware devices, allocate memory, or execute programs.

The term “System Call (syscall)” as used herein in the specification may refer to a mechanism that application software uses to request services from the operating system such as open (files and sockets), write (files and sockets), and connect, etc. An operating system typically provides several hundred system calls to application programs. The application program uses a system call just like any other function call. The standard library provides the function body for the system call, which provide the mechanism to invoke the operating system routine for the system call.

The term “Interrupt” as used herein in the specification may be defined as, devices attached to a computer system issue interrupts to the operating system to force it to handle events like data read, data write or arrival of network packets etc. Interrupts are identified by numbers such as each different hardware has a unique interrupt number. The interrupts may also be referred as traps.

The term “Kernel trap handler” as used herein in the specification may handle the interrupts. The kernel trap handler may look up the handler function to service the interrupt using the interrupt number passed to it. For example;
a. Upon arrival of data packets, a network card may trigger the networking interrupt, and trap handler delegates it to the networking interrupt handle,
b. Pressing a key on the keyboard may trigger the keyboard interrupt, and trap handler delegates it to the keyboard interrupt handler, and
c. the system call interrupt is handled by the system call interrupt handler.

The term “System Call Dispatcher (sys_call_dispatcher)” as used herein in the specification may examine the system call number to locate the function to handle the specific system call. To locate the function to execute a system call, the operating system can use a vector or a big switch.

The term “System call vector” as used herein in the specification may refer to an array. The array stores the functions that implement the system calls. The system call dispatcher uses the system call number as an index into this array to locate the specific system call handler. For example, system call number to open a file is 5, so the 5th element in this array contains the address of the function to serve the system call for open. The system call vector provides a convenience to security software like CipherTrust Transparent Encryption (CTE), which need to inspect certain system calls before the operating system can handle them.

The term “System Call big switch” as used herein in the specification may use a vector to use a switch logic to identify the handler function for the system calls. The vector is replaced by a large block of instructions (switch case) that decides which function to execute based on the system call number.

The term “program” as used herein in the specification may refer to set of instructions stored in an executable file to achieve a certain output.

The term “Operating System Image” as used herein in the specification may refer to a file that contains an operating system, programs, and any related data files. The operating system image is used to install and configure a new operating system on a computer.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 illustrates a block diagram of an environment of a system for handling system call of the operating system executing in a computing environment, in accordance with an example embodiment;

FIG. 2 illustrates a block diagram illustrating various modules within a memory of a computing device configured for handling system call of the operating system executing in the computing environment, in accordance with an example embodiment;

FIG. 3 illustrates a block diagram of an exemplary system architecture for handling system call of the operating system executing in the computing environment, in accordance with an example embodiment;

FIG. 4 illustrates a flow diagram of a method for handling system call of the operating system executing in the computing environment, in accordance with an example embodiment;

FIG. 5 illustrate an exemplary flow chart of a method for handling system call of the operating system executing in the computing environment, in accordance with an example embodiment; and

FIG. 6 illustrates a block diagram of an exemplary computer system for implementing embodiments consistent with the present disclosure.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not comprise only those components or steps but may comprise other components or steps not expressly listed or inherent to such setup, device, or method. In other words, one or more elements in a system or apparatus proceeded by “comprises . . . a” does not, without more constraints, preclude the existence of other elements or additional elements in the system or method.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

The method and system for handling system call of an operating system executing in a computing environment comprises an application. The application makes a request, which typically triggers a system call. The system call is a request to the operating system to perform a low-level task such as file manipulation, memory management, or communication. Further, the system call passes through a kernel trap handler, that is first point of interaction between user-space applications and the kernel. The operating system takes control of the process flow to execute the system call via the kernel trap handler. Once in the kernel trap handler, the system call dispatcher processes the request. The system call dispatcher is responsible for identifying the type of system call requested and route the system call accordingly. In an embodiment, the system call dispatcher may be a big switch routine. The big switch routine uses a switch logic to identify the handler function for the system calls. At this point, the system call dispatcher identifies the appropriate system call handler based on a system call number. Further, the system call handler is executed based on a system call number and the instructions. Upon executing the system call handler, the system call flow moves deeper into the system stack for further processing, including returning results to the application or performing additional operations based on the system call.

In some embodiments, the system call dispatcher may be a vector of system call handler functions. The system call dispatcher uses a vector to organize its system calls. The “vector sys call dispatcher” dispatches the system call to its appropriate handler such as handling read, write, or other system calls. Further, the execution continues in the system stack.

As described earlier, conventional methods of handling system call of the operating system executing in the computing environment rely on static system call dispatchers that handle calls using fixed vectors, which are integrated into the operating system's image. This creates challenges when the operating system is updated or modified, requiring constant adjustments to the security software. Such systems are not easily adaptable to changing operating system behaviours or evolving system call types, making them inefficient and prone to errors in a dynamic environment. The present disclosure addresses these challenges by introducing a method and system for handling system call of the operating system executing in the computing environment. The proposed method and system propose a customizable system call dispatcher that can inspect and modify calls, enhancing security and enabling seamless integration with evolving operating system architectures. The customizable system call dispatcher may refer to a customizable system call vector table to execute the system call handler corresponding to the system call.

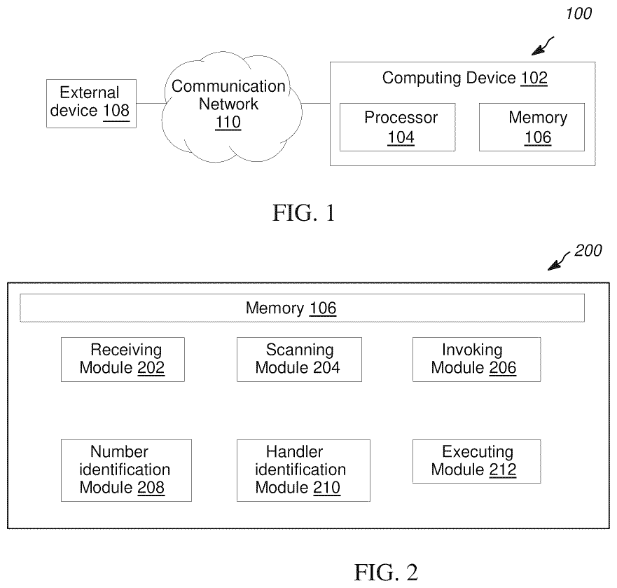

Embodiments of the present disclosure may provide a method, a system for handling system call of an operating system executing in a computing environment. The method, the system for handling system call of the operating system executing in the computing environment in such a flexible manner are described with reference to FIG. 1 to FIG. 6 as detailed below.

FIG. 1 illustrates a block diagram of an environment of a system 100 for handling system call of the operating system executing in the computing environment, in accordance with an example embodiment. The system 100 is designed to facilitate efficient and secure system calls execution in the operating system by introducing a private system call dispatcher. The system 100 comprises a computing device 102 and an external device 108. The computing device 102 may be communicatively coupled with the external device 108 via a communication network 110. Examples of the computing device 102 may comprise, but are not limited to, a server, a desktop, a laptop, a notebook, a tablet, a smartphone, a mobile phone, an application server, or the like.

The communication network 110 may be wired, wireless, or any combination of wired and wireless communication networks, such as cellular, Wi-Fi, internet, local area networks, or the like. In one embodiment, the communication network 110 may comprise one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fibre-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The computing device 102 may comprise a memory 106, and a processor 104. The term “memory” used herein may refer to any computer-readable storage medium, for example, volatile memory, random access memory (RAM), non-volatile memory, read only memory (ROM), or flash memory. The memory 106 may comprise a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 104 may retrieve computer program code instructions that may be stored in the memory 106 for execution of the computer program code instructions. The processor 104 may be embodied in a number of different ways. For example, the processor 104 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 104 may comprise one or more processing cores configured to perform independently. A multi-core processor may enable multiprocessing within a single physical package. Additionally, or alternatively, the processor 104 may comprise one or more processors configured in tandem via the bus to enable independent execution of instructions, pipelining, and/or multithreading.

Additionally, or alternatively, the processor 104 may comprise one or more processors capable of processing large volumes of workloads and operations to provide support for big data analysis. In an example embodiment, the processor 104 may be in communication with a memory 106 via a bus for passing information among components of the system 100.

The memory 106 may be non-transitory and may comprise, for example, one or more volatile and/or non-volatile memories. In other words, for example, the memory 106 may be an electronic storage device (for example, a computer readable storage medium) comprising gates configured to store data (for example, bits) that may be retrievable by a machine (for example, a computing device like the processor 104). The memory 106 may be configured to store information, data, contents, applications, instructions, or the like, for enabling the apparatus to carry out various functions in accordance with an example embodiment of the present disclosure. For example, the memory 106 may be configured to buffer input data for processing by the processor 104.

The computing device 102 may be capable of executing system calls based on a private system call dispatcher. The private system call dispatcher may refuse to execute, partially execute, execute a sequence of generic and custom instructions and delegate to the operating system provided kernel function, based on the requirements of the specific system call. The memory 106 may store instructions that, when executed by the processor 104, cause the computing device 102 to perform one or more operations of the present disclosure which will be described in greater detail in conjunction with FIG. 2. The computing device 102 is responsible for performing tasks such as receiving system call, scanning instructions, invoking dispatcher, identifying system call number, identifying system call handler, and executing system call handler.

In an embodiment, the computing device 102 receive at least one system call from an application in form of a number and corresponding arguments. Each of at least one of the system call comprises a set of instructions. Further, the computing device 102 scan the set of instructions of the operating system trap handler to identify a binary opcode. The computing device 102 further invoke a private system call dispatcher at the binary opcode. The private system call dispatcher refers to a private system call vector table. Further, the computing device 102 receive a system call number corresponding to the at least one system call by the private system call dispatcher. Such system call number appraises the system call dispatcher about which system call service was requested by the application. The computing device 102 identify a system call handler corresponding to at least one of the system call based on the private system call vector table and the system call number. The private system call vector table is referred to identify the system call handler based on the system call number. The computing device 102 further execute the system call handler based on the at least one of the system call.

The external devices 108 may be various hardware and software tools that may be integrated with the system 100 to enhance its functionality. The external device 108 may be used for receiving the system call from one or more applications running on the OS. The complete process followed by the system 100 is explained in detail in conjunction with FIG. 2 to FIG. 6.

FIG. 2 illustrates a block diagram 200 illustrating various modules within the memory 106 of the computing device 102 configured for handling system call of the operating system executing in the computing environment, in accordance with an example embodiment. The memory 106 may comprise a receiving module 202, a scanning module 204, an invoking module 206, a number receiving module 208, a handler identification module 210, and an executing module 212.

The receiving module 202 is responsible for receiving at least one system call from an application. Each of at least one of the system call comprises a set of instructions. The application is installed on the operating system, accessible to the user via the external device 108. The receiving module 202 may receive the system call automatically or provided by the user via the external device 108. The set of instructions are special low-level machine instructions that enable the application to request services from the operating system's kernel. The set of instructions initiate the system call, transitioning the program from user mode (for example, restricted access) to kernel mode (for example, privileged access). In kernel mode, the operating system may manage hardware resources or execute sensitive operations like file I/O, memory management, or process control. The set of instructions may be implemented in various architectures, but not limited to, ×86 Architecture, Reduced Instruction Set Computing (RISC-V) architecture, and Acorn RISC Machine (ARM) architecture. Further, the receiving module 202 may transmit the system call to the scanning module 204.

The scanning module 204 is configured to scan the set of instructions of the operating system trap handler to identify a binary opcode. The scanning module 204 is designed to break down or scan a set of machine-level instructions used by the trap handler to identify specific binary opcodes. When the trap handler receives the system call or trap, the trap handler operates on low-level machine instructions encoded in binary language. The scanning module 204 takes the binary instructions and converts them into human-readable or structured representations such as assembly language to analyze their components. The binary opcode is a key part of the instruction that defines the operation the computing device 102 must perform such as arithmetic operations, memory access, or control flow. By identifying the binary opcode, the operating system may determine the exact type of operation requested or the cause of the trap, facilitating the appropriate response, such as executing a system call or handling an exception. The process ensures accurate execution and handling of privileged operations by the kernel while maintaining control over low-level program behavior.

Upon identifying the binary opcode, the invoking module 206 is responsible for invoking a private system call dispatcher at the binary opcode. The invoking module 206 may replace a default system call dispatcher with the private system call dispatcher. The private system call dispatcher refers to a private system call vector table. The private system call vector table comprises a plurality of entries of system call handlers corresponding to each of at least one of the system calls. Each of at least one of the system call corresponds to one system call number. In the run time disassembly of the instructions, the binary opcode invokes the private system call dispatcher by replacing the default system call dispatcher.

The number receiving module 208 is responsible for receiving a system call number corresponding to the at least one system calls by the private system call dispatcher. Each of at least one of the system call corresponds to one unique system call number. The system call number acts as an identification for the system call.

The handler identification module 210 is responsible for identifying a system call handler corresponding to at least one of the system calls based on the private system call vector table and the system call number. The private system call vector table is referred to identify the system call handler based on the system call number. The private system call vector table may comprise plurality of entries of system call handlers corresponding to each of at least one of the system call. The system call number is used as an index in the private system call vector table to identify the system call handler.

In an embodiment, the private system call vector table is a specialized mechanism that allows interception and handling of system calls before the operating system processes the system calls. The private system call vector table provides flexibility for security software to inspect and alter the behaviour of specific system calls. The private system call vector table allows the insertion of custom system call handlers into the system call execution flow. In an exemplary embodiment, the operating system trap handler is modified to call the private system call dispatcher instead of the default dispatcher. Further, the private system call dispatcher identifies the system call handler by using the system call number provided in the trap. The private system call dispatcher refer to the private system call vector table to identify the system call handler corresponding to the system call. The private system call vector table may comprise custom handlers for the system calls that need interception and original operating system provided handlers for the system calls that may not need to be intercepted (for example passthrough system calls).

Further, the executing module 212 is configured to execute the system call handler based on at least one of the system call. The executing module 212 may respond to the requested system call by executing the system call handler identified based on the system call number. The executing module 212 may also identify the stub function based on the index and the system call handler. The stub function may comprise additional instructions to handle a request from the trap handler. Further, the executing module 212 executes the stub function, before executing at least one of the system call handlers based on the at least one of the system calls. The stub function may serve, but not limited to, as a temporary implementation that mimics the behavior of a more complex function such as system call without executing full logic. The full logic may refer to complex functionalities of the system calls. The stub function may be, but not limited to, utilized to simulate the response or output of the system call being called, allowing developers to test other parts of the system that depend on this functionality without requiring the complete implementation.

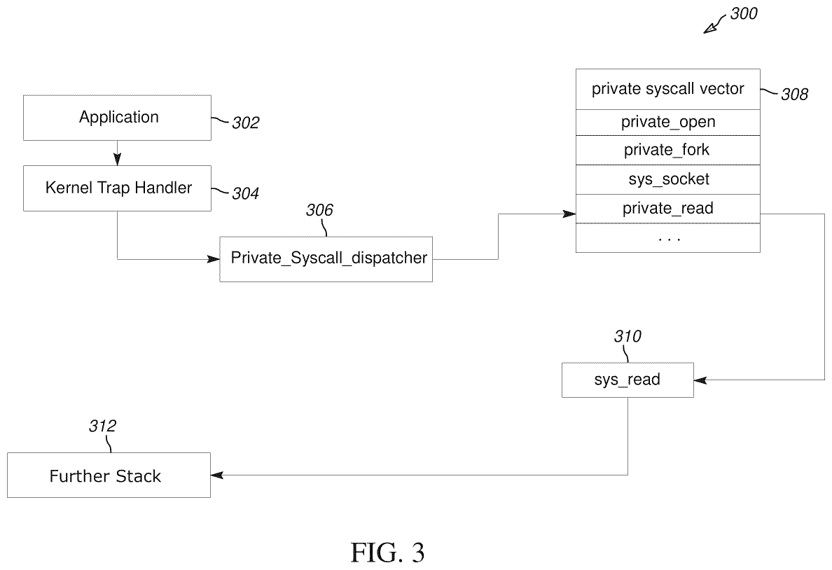

FIG. 3 illustrates a block diagram of an exemplary system architecture 300 for handling system call of the operating system executing in the computing environment, in accordance with an example embodiment. The system architecture 300 is analogous to the computing device 102 of the system 100. The system architecture 300 may comprise an application 302, a kernel trap handler 304, a private system call dispatcher 306, a private system call vector table 308, a system read 310, and a further stack 312.

The application 302 is installed on the operating system of the computing device 102. The application 302 is a software that a user, either a human or another software may use such as web browser, email client, excel, games, command prompt, etc. Further, the operating system provides management for hardware like storage devices, network interfaces, along with providing process and memory management, amongst a host of other capabilities. The operating system may be, but not limited to, Microsoft Windows, Linux, MacOS, and Android. The operating system provides a mechanism called the system calls through which application 302 may access hardware devices, allocate memory, or execute programs. Further, the application 302 may send at least one system call. Each of at least one of the system calls comprises a set of instructions. The set of instructions may comprise special low-level machine instructions that enable the application 302 to request services from the operating system's kernel.

The kernel trap handler 304 may receive the at least one of system call. The system calls are transferred from the application 302 to the operating system using interrupts. A dedicated interrupt number is reserved for transmission purposes (for example, 0×80). In an embodiment, the devices such as external device 108 attached to a computer system may issue interrupts to the operating system, forcing the operating system to handle events like data read, write or arrival of network packets etc. Interrupts may be identified by numbers. Each different hardware may have a unique interrupt number. Interrupts may also be referred to as traps. For example, to open a file “/test/hello. txt”, the kernel trap handler may pass the following variables to the operating system:
Interrupt number: 0×80
System call number for open: 5
File name: “/test/hello. txt”
Open Flags: “READ AND WRITE”

Further, the kernel trap handler 304 may look up the handler function to service the interrupt using the interrupt number passed to the kernel trap handler 304. For example;
a. Upon arrival of packets to a network card may trigger the networking interrupt, and kernel trap handler 304 may delegate it to the networking handler,
b. Pressing a key on the keyboard may trigger the keyboard interrupt and trap handler may delegate it to the keyboard handler, and
c. The system call interrupt may be handled by the private system call dispatcher 306.

In an embodiment, the kernel trap handler 304 may invoke private system call dispatcher 306 to serve the at least one system call. The private system call dispatcher 306 may examine the system call number to locate the function to handle the specific system call. The private system call vector table 308 comprises a plurality of entries of system call handlers corresponding to each of the at least one system calls. It should be noted that a subset of system call handlers (such as open, read etc). from the plurality of entries may be interposed, while other subset of system call handlers (such as socket, send to, etc.) may be executed unmodified. For a system call number that has been issued by the application, the private system call vector table 308 may contain a stub function, which is a wrapper on the system call handler, this implements interposed execution of the system call. For interposed execution, the wrapper function may execute instructions to implement security features and then pass control to the system call handler. Alternatively, for the system call number provided by the application, the private system call vector table 308 may contain a direct reference to the system call handler, this implements unmodified execution of the system call.

Each of the at least one system calls corresponds to one unique system call number. The private system call dispatcher 306 identifies the system call handler to be executed by using the system call number as an index into a private system call vector table 308. In an exemplary embodiment, the private system call vector table 308 is referred to identify the system call handler based on the system call number.

As an example of an unmodified execution, for a system call (e.g. socket), the system socket function 310 may execute the socket system call handler based on the private system call vector table 308. The system socket function 310 executes the system call through the identified system call handler from the private system call vector table 306. The identified socket system call handler may be executed to perform the desired action according to the set of instructions. The further stack 312 may perform, analyze, or execute the complete functionality of the socket system call.

In another exemplary embodiment, for (open), for a system call which has been interposed, for an open system call, the corresponding function may be a system open function. Further, the system call number is used to identify a stub function to be executed before the system call handler. The stub function may execute its instructions and, in the end, executes the system call handler function. Further, an exit status from the system call handler may be propagated back to the application 302.

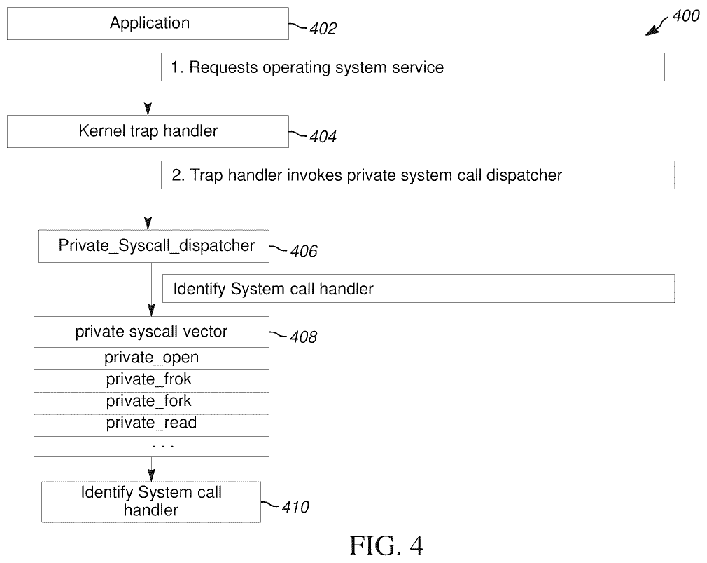

FIG. 4 illustrates an exemplary flow diagram 400 for handling system call of the operating system executing in the computing environment, in accordance with an example embodiment. It will be understood that each block of the flow diagram of the method 400 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 106 of the computing device 102, employing an embodiment of the present disclosure and executed by a processor 104. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 4 illustrates a flow diagram 400 of the method for handling system call of the operating system executing in the computing environment, in accordance with an example embodiment. The method 400 is implemented by the system architecture 300. At step 402, an operating system service is requested by the application 302, which the operating system handles by making a system trap. One parameter identifies the operating system service with a number such as trap number. The system trap may be a software-generated interrupt that transitions control from user mode to kernel mode in the operating system. The system trap occurs when a running program encounters an event or condition that requires the operating system's intervention or a system-level service. The system traps are used to handle exceptions such as divide-by-zero errors or to request services from the operating system such as via system calls.

In an exemplary embodiment, the application 302 needs to perform an operation such as opening a file or reading from a network socket. The application 302 issues a system call associated with the operation through a library function such as open( ) or read( ) in the C standard library. The application 302 issues the system call using a function provided by a standard library such as glibc in Linux operating system. Further, the library function triggers the system trap using a pre-defined trap number such as 0×80 in Linux operating system. The system trap results in a context switch, transferring control from user mode, where applications run to the kernel mode, where the OS operates, ensuring that only trusted code has access to hardware and critical system functions.

At step 404, a private system call dispatcher is invoked by the kernel trap handler based on the request and the system trap number. The trap number is validated and used to access a vector of addresses of kernel-level functions by the kernel trap handler 304. At step 406, the private system call dispatcher 306 may be invoked at the binary opcode. The private system call dispatcher 306 identifies the system call handler from the private system call vector table as explained in detail in step 408.

At step 408, a system call handler corresponding to the system call is identified based on the private system call vector table 308 and the system call number. The private system call vector table 308 is referred to identify the system call handler based on the system call number by the private system call dispatcher 306. In an embodiment, the system call number is received by the system call dispatcher 306 from the application 302. Further, the private system call dispatcher 306 refer to the private system call vector table 308 to identify the system call handler based on the system call number. At step 410, the system call handler is executed to perform the function based on the system call number.

In an exemplary embodiment, a Linux Operating system is installed on a device. Further, an application is installed on the Linux Operating system to retrieve and read file from the device. To read a file from the device, the application issues a system call such as read ( ) corresponding to read function via a glibc library. Further, the glibc library issues a system trap to Linux operating system along with arguments provided by the application. The arguments of the application are file names, descriptors, or flags, etc. The system trap acts as a signal to the Linux operating system, indicating that a system call needs to be processed. Once the system trap is issued, a system trap handler in the kernel identifies the type of request based on a system trap number. The system trap number is a unique identifier related to the system trap. Further, the system trap handler invokes a private system call dispatcher to process the system call (read ( )). The private system call dispatcher identifies the system call to be executed by using the system call number as an index into a private system call vector table. The system call number (such as 5 for reading a file) is a unique identifier related to the system call. The private system call vector table comprises the system call handler addresses. In simpler words, if the system call number is known, the private system call dispatcher 306 identifies the system call handler by simply referring to the private system call vector table. The system call number is also used to identify a stub function related to the system call. The private system call dispatcher refers the private system call vector table using the system call number (5, as an example for read system call) to identify the corresponding system call handler. Further, the stub function, comprising the instructions to handle the request (such as read) from the trap layer, is executed. These instructions may be required to implement features of the security software and is executed before the system call handler.

Finally, the system call handler is executed based on the system call number such as read ( ) to read the corresponding file from the device, and an exit status such as success, failure, or in progress is propagated back to the application.

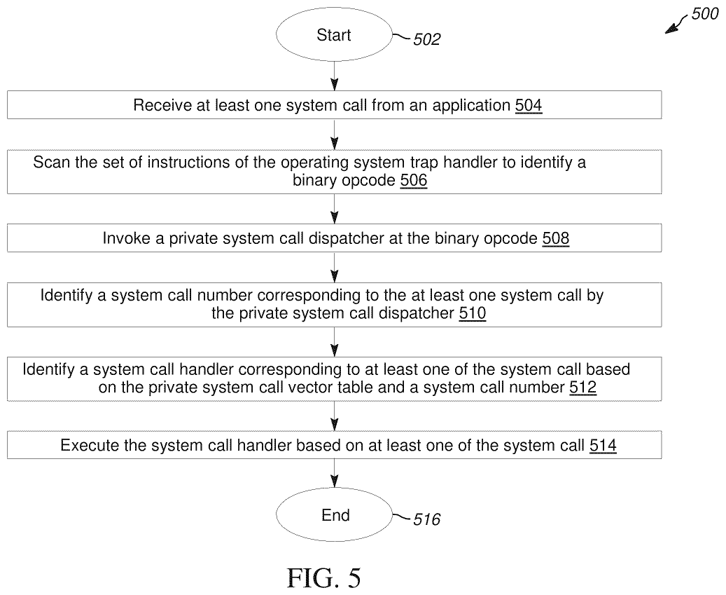

FIG. 5 illustrates an exemplary flow chart 500 for handling system call of the operating system executing in the computing environment, in accordance with an example embodiment. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 106 of the computing device 102, employing an embodiment of the present disclosure and executed by a processor 104. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 5 is explained in conjunction with elements from FIGS. 1, 2, 3, and 4. At step 502, the method 500 is initiated. The method 500, at step 504 may comprise receiving at least one system call from an application 302. Each of the at least one system call comprises a set of instructions. The system call allows the application 302 to request a service from the operating system's kernel. The service may comprise tasks like interacting with hardware devices such as reading from a disk or writing to a file, handling memory, creating processes, and handling network communication.

The method, at step 506 may comprise scanning the set of instructions of the operating system trap handler 304 to identify a binary opcode. The binary opcode is a portion of the set of instructions that specifies the operation to be performed by the computing device 102. In binary form, the binary opcode is a sequence of bits that represent a specific command to the processor 104, such as arithmetic operations (for example addition, subtraction), data movement (for example loading or storing data), or control flow (for example branching, jumping).

The method, at step 508, may comprise invoking a private system call dispatcher 306 at the binary opcode. The private system call dispatcher 306 refers to a private system call vector table 308. The invoking private system call dispatcher 306 including replacing a default system call dispatcher with the private system call dispatcher 306. The private system call vector table 308 comprises a plurality of entries of the system call handlers corresponding to each of the at least one system calls.

Further, the method, at step 510, may comprise receiving a system call number corresponding to the at least one system call by the private system call dispatcher 306. The system call number is used as an index in the private system call vector table 308 to identify the system call handler. Each of at least one of the system call corresponds to one system call number.

The method, at step 512, may comprise identifying a system call handler corresponding to at least one of the system call based on the private system call vector table 308 and the system call number. The private system call vector table 308 is referred to identify the system call handler based on the system call number.

The method, at step 514, may further comprise executing the system call handler based on the at least one of the system call. In some embodiments, the method may comprise identifying a stub function based on the system call number. The method 500 ends at step 516.

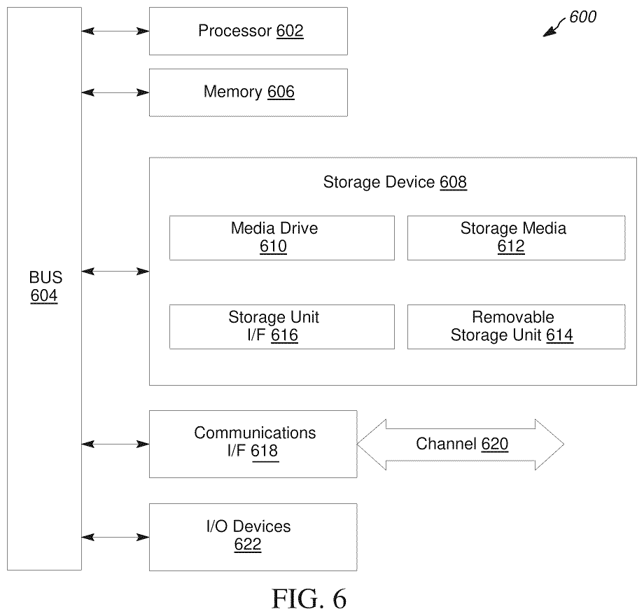

The disclosed methods and systems may be executed on a conventional or general-purpose computing system, such as a personal computer (PC) or server. Referring to FIG. 6, an exemplary computing system 600 is illustrated, which may implement processing functionality for various embodiments (e.g., as a SIMD device, client device, server device, or one or more processors). Those skilled in the art will recognize that other computing systems or architectures may also be used to implement the invention. The computing system 600 may represent a user device, such as a desktop, laptop, mobile phone, personal entertainment device, DVR, or any other special or general-purpose computing device appropriate for a given application or environment. The computing system 600 may comprise one or more processors, such as processor 602, implemented using a general-purpose or specialized processing engine, such as a microprocessor, microcontroller, or other control logic. In some embodiments, processor 602 may be an AI processor, implemented as a Tensor Processing Unit (TPU), graphical processing unit (GPU), or custom-programmable solution, such as a Field-Programmable Gate Array (FPGA).

The computing system 600 may further comprise memory 606 (e.g., Random Access Memory (RAM) or other dynamic memory) for storing instructions and information to be executed by processor 602. Memory 606 may also store temporary variables or intermediate information during execution. Additionally, the computing system 600 may comprise a read-only memory (ROM) or other static storage device connected to bus 604 for storing static information and instructions for

### Processor 602.

Storage devices 608 may also be comprised in computing system 600, consisting of, for example, a media drive 610 and a removable storage interface. Media drive 610 may support fixed or removable storage media, such as hard disk drives, floppy drives, magnetic tape drives, SD card ports, USB ports, optical disk drives (e.g., CD or DVD drives), or other media. Storage media 612 may comprise hard disks, magnetic tapes, flash drives, or other media that can be read and written to by media drive 610. Storage media 612 may store computer-readable software or data.

Alternatively, storage devices 608 may comprise other means for loading computer programs or data into computing system 600, such as removable storage unit 614 and interface 616, program cartridges, removable memory (e.g., flash memory), memory slots, and similar storage units and interfaces.

Computing system 600 may also comprise a communications interface 618 to transfer software and data between external devices 112 and system 600. Examples comprise network interfaces (e.g., Ethernet), communication ports (e.g., USB, micro-USB), Near Field Communication (NFC), and other protocols. The signals transferred via communications interface 618 may comprise electronic, electromagnetic, optical, or other forms of transmission through channel 620, which may utilize wireless mediums, fibre optics, wires, or cables.

Computing system 600 may also comprise Input/Output (I/O) devices 622, such as a display, keypad, microphone, speakers, vibration motors, LED indicators, etc., allowing user interaction and feedback. The term “computer-readable medium” may refer to any storage medium used, such as memory 606, storage devices 608, removable storage unit 614, or signal(s) on channel 620. Such media may store sequences of instructions, or “computer program code,” which, when executed, enable computing system 600 to perform the methods and functions described in embodiments of the invention.

In embodiments where elements are implemented in software, the software may be stored on a computer-readable medium and loaded into computing system 600 via removable storage unit 614, media drive 610, or communications interface 618. When executed by processor 602, this control logic (e.g., software instructions or computer program code) causes processor 602 to perform the invention's functions as described.

As will be appreciated by those skilled in the art, the techniques described in the various embodiments discussed above are not routine, or conventional, or well understood in the art. The techniques discussed above provide for innovative solutions to address the challenges associated with generating holistic responses based on structural and semantic queries. The disclosed techniques offer several advantages over the existing methods as listed in below paragraphs.

The present disclosure introduces a method and a system that provides a custom/private system call dispatcher that inspects system calls before execution, ensuring that security software can examine, partially execute, or refuse system calls based on security needs, adding a layer of security that is not easily bypassed by operating system updates.

By repositioning the intercept higher in the system call execution stack, the security software remains resilient to changes in the operating system's implementation, such as the transition from system call vectors to the big switch method, reducing the need for recalibration with future operating system versions.

The custom dispatcher allows the selective interception of specific system calls. Security software can handle specific calls through a private vector table or pass others directly to the OS, improving control over system processes.

The present disclosure introduces minimal performance overhead since it only inspects, and processes calls of interest while allowing other system calls to pass through without modification, ensuring system performance remains optimal.

The ability to replace the standard operating system system call dispatcher with a private one offers security systems flexibility in how they manage evolving operating system behaviour without compromising functionality.

The present disclosure provides a method and a system that seamlessly integrate with existing operating system functionality by maintaining the original system call execution flow when necessary. The private vector table allows for selective interception, meaning system calls that do not require inspection can be handled by the operating system without modification, ensuring compatibility and stability.

The disclosed techniques offer several applications as listed in below paragraphs.

The system may be used in security solutions that need to inspect system calls for potential vulnerabilities or threats before the operating system processes them. This can help prevent malicious actions, such as unauthorized access or system manipulation.

The method and the system may be integrated into operating systems to provide an additional security layer that inspects system calls, ensuring that only safe and authorized calls are executed, thus fortifying the operating system against exploits.

The custom system call dispatcher may be utilized in monitoring tools designed to track and log specific system calls for performance analysis, auditing, or forensic purposes, allowing administrators to monitor the system's behaviour at a low level.

Organizations that need to enforce strict compliance with security policies can use this system to ensure that only system calls adhering to specific protocols are allowed to proceed, helping to maintain regulatory or internal policy standards.

In cloud or virtualized infrastructure, the system may be deployed to ensure that hypervisors or other OS-level software only execute safe system calls, offering an added layer of security for virtual machines and cloud services.

By integrating this system into an IDPS, the system call flow can be monitored for suspicious activity, allowing real-time prevention of potential threats or unauthorized actions within the operating system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be comprised within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A method (500) for handling system call of an operating system executing in a computing environment, the method (500) comprising:
receiving at least one system call from an application (302), wherein each of the at least one of the system call comprises a set of instructions;
scanning the set of instructions of the operating system trap handler (304) to identify a binary opcode;
invoking a private system call dispatcher (306) at the binary opcode, wherein the private system call dispatcher (306) refers to a private system call vector table (308);
receiving a system call number corresponding to the at least one system call by the private system call dispatcher (306);
identifying a system call handler corresponding to at least one of the system call based on the private system call vector table (308) and the system call number, wherein the private system call vector table (308) is referred to identify the system call handler based on the system call number; and
executing the system call handler based on the at least one of the system call.

2. The method (500) of claim 1, wherein the private system call vector table (308) comprises a plurality of entries of system call handlers corresponding to each of at least one of the system calls, wherein the plurality of entries comprise a subset of system call handlers that are interposed, and wherein each of at least one of the system call corresponds to one system call number.

3. The method (500) of claim 1, wherein the system call number is used as an index in the private system call vector table (308) to identify the system call handler.

4. The method (500) of claim 1, further comprising:
identifying a stub function based on the index in the private system call vector table and the system call handler, wherein the stub function comprises additional instructions to handle a request from a trap layer; and
executing the stub function, before executing the system call handler based on the at least one of the system call number.

5. The method (500) of claim 1, wherein the step of invoking of the private system call dispatcher (306) comprising replacing a default system call dispatcher with the private system call dispatcher (306).

6. A system (100) for handling system call of an operating system executing in a computing environment, the system (100) comprising:
a processor (104); and
a memory (106) communicatively coupled to the processor (104), wherein the memory (106) stores processor instructions, which when executed by the processor (104), cause the processor (104) to:
receive at least one system call from an application, wherein each of at least one of the system call comprises a set of instructions:
scan the set of instructions of the operating system trap handler (304) to identify a binary opcode;
invoke a private system call dispatcher (306) at the binary opcode, wherein the private system call dispatcher (306) refers to a private system call vector table (308);
receive a system call number corresponding to the at least one system call by the private system call dispatcher (306);
identify a system call handler corresponding to at least one of the system call based on the private system call vector table (308) and the system call number, wherein the private system call vector table (308) is referred to identify the system call handler based on the system call number; and
execute the system call handler based on at least one of the system call.

7. The system (100) of claim 6, wherein the private system call vector table (308) comprises a plurality of entries of system call handlers corresponding to each of at least one of the system calls, wherein the plurality of entries comprise a subset of system call handlers that are interposed, and wherein each of at least one of the system call corresponds to one system call number.

8. The system (100) of claims 6, wherein the system call number is used as an index in the private system call vector table (308) to identify the system call handler.

9. The system (100) of claim 6, wherein the processor (104) instructions, on execution, cause the processor (104) to:
identify a stub function based on the index in the private system call vector table and system call handler, wherein the stub function comprises additional instructions to handle a request from a trap layer; and
execute the stub function, before executing the system call handler based on at least one of the system call number.

10. The system (100) of claim 6, wherein to invoke the private system call dispatcher (306), the processor (104) instructions, on execution, cause the processor (104) to replace a default system call dispatcher with the private system call dispatcher (306).

11. A non-transitory computer-readable medium storing computer-executable instructions for handling system call of an operating system executing in a computing environment, the computer-executable instructions configured for:
receiving at least one system call from an application, wherein each of at least one of the system call comprises a set of instructions:
scanning the set of instructions of the operating system trap handler (304) to identify a binary opcode;
invoking a private system call dispatcher (306) at the binary opcode, wherein the private system call dispatcher (306) refers to a private system call vector table (308);
receiving a system call number corresponding to the at least one system call by the private system call dispatcher (306);
identifying a system call handler corresponding to at least one of the system call based on the private system call vector table (308) and the system call number, wherein the private system call vector table (308) is referred to identify the system call handler based on the system call number; and
executing the system call handler based on at least one of the system call.

12. The non-transitory computer-readable medium as in claim 11, wherein the private system call vector table (308) comprises a plurality of entries of system call handlers corresponding to each of at least one of the system calls, wherein the plurality of entries comprise a subset of system call handlers that are interposed, and wherein each of at least one of the system call corresponds to one system call number.

13. The non-transitory computer-readable medium of claim 11, wherein the system call number is used as an index in the private system call vector table (308) to identify the system call handler.

14. The non-transitory computer-readable medium of claim 11, further comprising:
identifying a stub function based on the index in the private system call vector table and the system call handler, wherein the stub function comprises additional instructions to handle a request from a trap layer; and
executing the stub function, before executing the system call handler based on the at least one of the system call number.

15. The non-transitory computer-readable medium of claim 11, wherein the step of invoking of the private system call dispatcher (306) comprising replacing a default system call dispatcher with the private system call dispatcher (306).
